(19) United States
(12) Patent Application Publication
(10) Pub. No.: US 2011/0090598 A1
(43) Pub. Date: Apr. 21, 2011

(54) HEAD-SLIDER CONFIGURED TO FLY WITH A VARIABLE FLY PITCH AND A HARD-DISK DRIVE INCLUDING THE HEAD-SLIDER

(76) Inventor: Yoshinori TAKEUCHI, Ibaraki-ken (JP)

(21) Appl. No.: 12/545,685

(22) Filed: Aug. 21, 2009

(30) Foreign Application Priority Data
Aug. 21, 2008 (JP) 2008-213259

(51) Int. Cl. G11B 21/21

(52) U.S. Cl. 360/236.4; G9B/21.026

(57) ABSTRACT

A head-slider. The head-slider includes a pair of leading-edge air-bearing surfaces formed on a leading-edge portion of a disk-facing slider-surface of the head-slider, a center air-bearing surface formed at a central portion of a trailing-edge portion of the disk-facing slider-surface, and a magnetic-recording head disposed at the central portion of the trailing-edge portion. At least one leading-edge air-bearing surface of the pair has a form of a partially truncated rectangle with a longitudinal axis of the partially truncated rectangle oriented substantially parallel to a longitudinal axis of the head-slider. The partially truncated rectangle is defined by a rectangle truncated so that a first corner portion on the inside-diameter side of the leading-edge air-bearing surface and a second corner portion on the outside-diameter side of the leading-edge air-bearing surface have been cut away to form a vertex of the partially truncated rectangle in proximity to the leading edge of the head-slider.

### CROSS-REFERENCE TO RELATED APPLICATION

This application claims priority from the Japanese Patent Application No. 2008-213259, filed Aug. 21, 2008, the disclosure of which is incorporated herein in its entirety by reference.

### TECHNICAL FIELD

Embodiments of the present invention relate to a head-slider configured to fly above a recording surface of a magnetic-recording disk with a variable fly pitch and a hard-disk drive (HDD) including the head-slider.

### BACKGROUND

Head-sliders mounted in prior-art hard-disk drives have the same basic configuration as shown in FIG. 16. FIG. 16 is a plan view showing a head-slider. A disk-facing slider-surface 108 of a slider 101 includes an air-bearing surface (ABS) 102, a shallow-recessed surface 104 having a first step slightly deeper than the ABS 102, and a deep-recessed surface 105 having a second step further deeper than the shallow-recessed surface 104 relative to the ABS 102. The ABS 102 includes a pair of left and right leading-edge ABSs 102a and 102b and a center pad 102c at a trailing-edge portion at which a magnetic-recording head 103 is disposed. The disk-facing slider-surface further includes a leading-edge shallow-recessed surface 104a, the leading-edge ABSs 102a, 102b, shallow-recessed side-rails 104b, and the deep-recessed surface 105 partially bounded by a shallow-recessed rail 104c around the center pad 102c. In the foregoing arrangements, air-bearing action by the shallow-recessed surface 104 and the ABS 102 generates lift to lift the slider 101 from the magnetic-recording disk and, at the same time, the deep-recessed surface 105 acts to generate a negative pressure. The use of both a positive pressure and the negative pressure achieves an adequate air-bearing stiffness for reliable lift. The use of both the positive and negative pressures also allows the magnetic-recording head 103 on the center pad 102c to be disposed in close proximity to the magnetic-recording disk. Currently widely used sliders are 1.25 mm in length, 0.7 mm in width, and 0.23 mm in thickness.

Narrower and smaller magnetic spacing in the hard-disk drive (HDD) is a natural consequence of the increasing trend toward higher data density. Achieving reliability between the magnetic-recording head and the magnetic-recording disk, on the other hand, raises another design issue. One technique to reduce the magnetic spacing is to reduce recession between the slider ABS and the magnetic-recording head. The magnetic-recording head is generally recessed about 2 nm from the slider ABS relative to the recording surface of the magnetic-recording disk, which is referred to by the term of art, “head-recession.” A lesser head-recession results in a greater likelihood of the lowest point of the magnetic-recording head being smaller than the lowest point of the slider. Consequently, contact of the magnetic-recording head with protrusions or contaminants on the recording surface of the magnetic-recording disk may degrade characteristics of, or even destroy, the read element or the write element of the magnetic-recording head and, in the worst case, may lead to a “head-crash,” a term of art which refers to a catastrophic head-disk interaction (HDI). Thus, manufacturing and design engineers engaged in the manufacturing and development of magnetic-recording heads are interested in designing magnetic-recording heads less susceptible to head-disk interactions (HDIs).

### SUMMARY

Embodiments of the present invention include a head-slider. The head-slider includes a pair of leading-edge air-bearing surfaces formed on a leading-edge portion of a disk-facing slider-surface of the head-slider, a center air-bearing surface formed at a central portion of a trailing-edge portion of the disk-facing slider-surface, and a magnetic-recording head disposed at the central portion of the trailing-edge portion. At least one leading-edge air-bearing surface of the pair has a form of a partially truncated rectangle with a longitudinal axis of the partially truncated rectangle oriented substantially parallel to a longitudinal axis of the head-slider. The partially truncated rectangle is defined by a rectangle truncated so that both a first corner portion on the inside-diameter side of the leading-edge air-bearing surface and a second corner portion on the outside-diameter side of the leading-edge air-bearing surface have been cut away to form a vertex of the partially truncated rectangle in proximity to the leading edge of the head-slider.

### DESCRIPTION OF THE DRAWINGS

The accompanying drawings, which are incorporated in and form a part of this specification, illustrate embodiments of the invention and, together with the description, serve to explain the embodiments of the present invention:

FIG. 1 is a perspective view showing an air-bearing surface (ABS) of a head-slider, in accordance with an embodiment of the present invention.

FIG. 2 is plan view showing the ABS of the head-slider of FIG. 1, in accordance with an embodiment of the present invention.

FIG. 3 is a perspective view showing a hard-disk drive (HDD) and a diagram showing a fly pitch of the head-slider, in accordance with an embodiment of the present invention.

FIGS. 4A and 4B are diagrams for illustrating the fly pitch of a magnetic-recording head and the lowest point of the head-slider, in accordance with an embodiment of the present invention.

FIG. 5 shows a relationship between an air leading direction and leading-edge ABSs at an inside-diameter (ID) position and an outside-diameter (OD) position of the head-slider, in accordance with an embodiment of the present invention.

FIG. 6 is a chart showing fly pitches of the head-slider at the ID position and the OD position, in accordance with an embodiment of the present invention.

FIG. 7 shows typical shapes of the leading-edge ABS of the head-slider, in accordance with embodiments of the present invention.

FIG. 8 is a chart showing a relationship between cut-length and fly pitches of the leading-edge ABS of the head-slider, in accordance with an embodiment of the present invention.

FIG. 9 is a chart showing a relationship between a cut-angle at a corner portion and fly pitches of the leading-edge ABS of the head-slider, in accordance with an embodiment of the present invention.

FIG. 10 is a chart showing a relationship between a flight parameter, given by the product of the cut-length and the square-root of the middle-diameter disk velocity, and fly pitches for a 1.25-mm-long slider, in accordance with an embodiment of the present invention.

FIG. 11 is a chart showing a relationship between a flight parameter, given by the product of the cut-length and the square-root of the middle-diameter disk velocity, and fly pitches for a 0.85-mm-long slider, in accordance with an embodiment of the present invention.

FIG. 12 is a chart showing effects of roll stiffness of the head-slider as function of radial location of the head-slider over the magnetic-recording disk, in accordance with an embodiment of the present invention.

FIG. 13 is a plan view showing an ABS of a head-slider, in accordance with another embodiment of the present invention.

FIG. 14 is a plan view showing an ABS of a head-slider, in accordance with yet another embodiment of the present invention.

FIG. 15 is a plan view showing an ABS of a head-slider using a 0.85-mm-long slider, in accordance with still another embodiment of the present invention.

FIG. 16 is a plan view showing an ABS of a head-slider using both positive and negative pressures according to prior art.

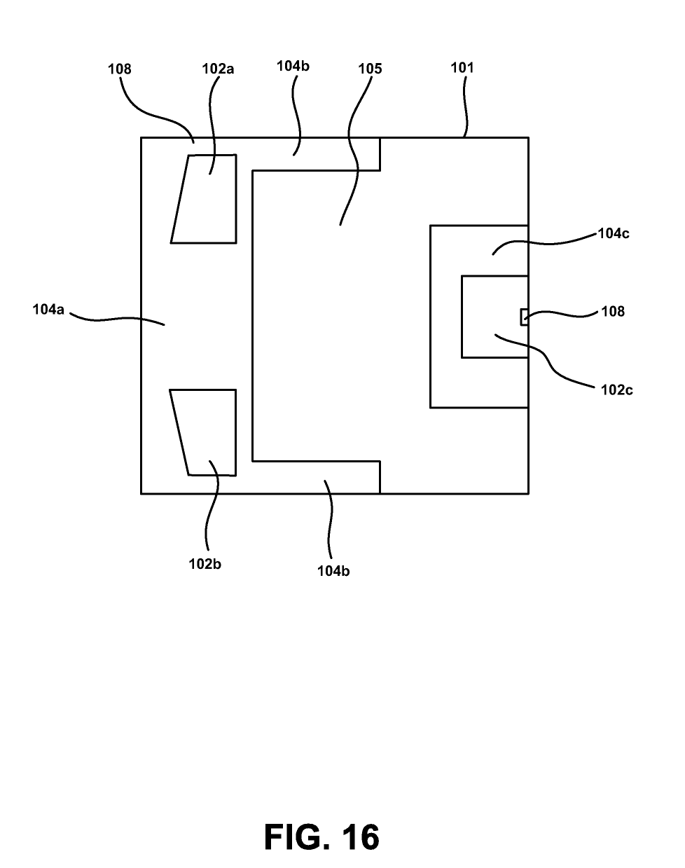

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be noted that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary.

### Description of Embodiments of the Present Invention for a Head-Slider Configured to Fly with a Variable Fly Pitch and a Hard-Disk Drive Including the Head-Slider

In accordance with embodiments of the present invention, it has become apparent that one factor that determines the lowest point of the head-slider is a posture angle of a flying head-slider, which is referred to herein by the terms of art, “fly pitch angle,” or alternatively, “fly pitch.” Prior-art head-sliders are arranged such that the fly pitch angle is the smallest on the inside diameter (ID) of the magnetic-recording disk and increases toward the middle diameter (MD) and outside diameter (OD) of the magnetic-recording disk. According to the prior-art arrangement, the likelihood of the side of the head-slider having the magnetic-recording head becoming the lowest point increases on an OD side at which the magnetic-recording disk spins at higher speeds, so that the clearance between the lowest point of the slider and the magnetic-recording disk is reduced. This results in increased likelihood of damage to the read element or the write element of the magnetic-recording head. This situation becomes even more serious with lesser head-recession that results from an attempt to make the magnetic spacing smaller, as described above. Another situation that arises is a reduced clearance between the magnetic-recording head and the magnetic-recording disk that is the result of the magnetic-recording head protruding more on the OD portion of the magnetic-recording disk when the magnetic-recording head writes to the OD portion due to the write current causing a thermal expansion of the write element of the magnetic-recording head in the direction of the magnetic-recording disk.

As used herein, the terms of art, “inside diameter, or ID,” “middle diameter, or MD,” and “outside diameter, or OD” are identified with the terms of art, “inner periphery,” “middle periphery,” and “outer periphery,” respectively; the terms of art, “inside-diameter, or ID,” and “outside-diameter, or OD,” are identified with the terms of art, “inner peripheral” and “outer peripheral” respectively; and, the acronyms ID, MD, OD are to be understood as referring to their corresponding adjectival or noun forms depending upon the context. For example, an inner peripheral side refers to the inner-diameter side, or ID side; and an outer peripheral side refers to the outside-diameter side, or OD side. For a head-slider configured to be flown over the magnetic-recording disk, the head-slider is configured to have a side more proximate to the OD of the magnetic-recording disk that is referred to herein as the OD side, which is identified with the outer peripheral side, and to have a side more proximate to the ID of the magnetic-recording disk that is referred to herein as the ID side, which is identified with the inner peripheral side. In addition, the head-slider includes four other sides: a side at a leading edge of the head-slider facing into the air-stream produced by the motion of the magnetic-recording disk, a leading-edge side; a side at a trailing edge of the head-slider facing away from the air-stream produced by the motion of the magnetic-recording disk, a trailing-edge side; a side facing the gimbal attachment at the end of the load beam, a gimbal-facing side; and, a side facing the magnetic-recording disk, a disk-facing side. Moreover, as used herein, the term of art “inside-diameter, or ID” may be used to refer to the sides of a structure, for example, such as an ABS, of the head-slider disposed towards the ID side of the head-slider; the term of art “outside-diameter, or OD” may be used to refer to the sides of a structure of the head-slider disposed towards the OD side of the head-slider; the term of art “leading-edge” may be used to refer to the sides of a structure of the head-slider disposed towards the leading-edge side of the head-slider; and, the term of art “trailing-edge”may be used to refer to the sides of a structure of the head-slider disposed towards the trailing-edge side of the head-slider.

In accordance with embodiments of the present invention, a fly pitch angle of a head-slider is made smaller on the OD portion than on the ID portion of a magnetic-recording disk.

In accordance with embodiments of the present invention, glide reliability of the HDD, a term of art which refers to the ability to fly the head-slider over the magnetic-recording disk without, or with minimal, contact with the recording surface of the magnetic-recording disk, is increased by maintaining a fly height of the head-slider from being reduced on the OD portion of the magnetic-recording disk.

As used herein, the term of art, “recording surface,” refers to the outermost surface of the magnetic-recording disk that is configured to be disposed in a configuration to receive magnetic flux from a magnetic-recording head for the recording of information within a magnetic-recording medium of the magnetic-recording disk; the magnetic-recording disk may be covered with ancillary layers in addition to the magnetic-recording medium, which may be disposed on top of the magnetic-recording medium of the magnetic-recording disk, and the outermost surfaces of one or more of such ancillary layers may be included in the outermost surface of the magnetic-recording disk. Therefore, the term of art, “recording surface,” does not imply that the outermost surface of the magnetic-recording disk is a medium for information storage, itself, but rather is arranged to face the magnetic-recording head in an orientation for the reception of the magnetic flux that records information within the magnetic-recording medium of the magnetic-recording disk.

In accordance with embodiments of the present invention, the head-slider includes: a pair of leading-edge ABSs formed on a leading-edge portion of a disk-facing slider-surface; a shallow-recessed surface formed proximate to a leading-edge portion of the leading-edge ABSs and between the leading-edge ABSs, the shallow-recessed surface being lower in height than the leading-edge ABSs; a center ABS formed at a central portion of a trailing-edge portion of the disk-facing slider-surface; a magnetic-recording head disposed at the central portion of the trailing-edge portion of the disk-spacing slider-surface; and a deep-recessed surface partially bounded by the leading-edge ABSs, the shallow-recessed surface and the center ABS, the deep-recessed surface being lower in height than the shallow-recessed surface. In accordance with an embodiment of the present invention, at least one, or alternatively one or more, leading-edge ABS of the pair has a form of a partially truncated rectangle with a longitudinal axis of the partially truncated rectangle oriented substantially parallel to a longitudinal axis of the head-slider. As used herein, the phrase, “a longitudinal axis of the partially truncated rectangle oriented substantially parallel to longitudinal axis of the head slider,” means that a long side of the partially truncated rectangle is oriented about parallel to a long side of the head-slider, as the head-slider also has about a rectangular shape. As used herein, the term of art, “partially truncated rectangle,” refers to an irregular pentagon formed from a rectangle from which two adjacent corners to a common side of the rectangle have been cut away to form the pentagon by replacing the common side with the cutting lines for cutting away the adjacent corners of the rectangle and a vertex lying on the original common side of the rectangle where the cutting lines meet. In accordance with an embodiment of the present invention, the partially truncated rectangle is defined by a rectangle truncated so that both a first corner portion on the ID side of the leading-edge ABS and a second corner portion on the OD side of the leading-edge ABS have been cut away to form a vertex of the partially truncated rectangle in proximity to the leading edge of the head-slider. In other words, with a vertex at a point on an OD side of a magnetic-recording disk in proximity to the leading-edge of the magnetic-recording head, a first corner portion defined on an ID side of the magnetic-recording head relative to the vertex and corresponding to a substantially triangular shape is removed from a substantial rectangle defined for each of the pair of leading-edge ABSs; and, a second corner portion defined on an OD side of the magnetic-recording head relative to the vertex and corresponding to another substantially triangular shape smaller than that of the first corner portion is removed from the rectangle defined for each of the pair of leading-edge ABSs to make the leading-edge portion of each of the leading-edge ABSs chevron-shaped. In this latter description of the configuration of the shape of the leading-edge ABSs, the substantially triangular shape removed from the ID side of the substantial rectangle is identified with the first corner portion cut away from the rectangle; and, the substantially triangular shape removed from the OD side of the substantial rectangle is identified with the second corner portion cut away from the rectangle.

In accordance with one embodiment of the present invention, both the first cut-away corner portion and the second cut-away corner portion have a substantially triangular shape.

In accordance with another embodiment of the present invention, the first cut-away corner portion is larger than the second cut-away corner portion.

In accordance with an embodiment of the present invention, a leading-edge portion of the at least one, or alternatively one or more, leading-edge ABS of the pair including the vertex of the partially truncated rectangle has a chevron-like shape.

In accordance with one embodiment of the present invention, the first cut-away corner portion on the ID side has a cut-length greater than or equal to 150 um in the longitudinal direction of the head-slider.

In accordance with another embodiment of the present invention, an angle of the first cut-away corner portion adjacent to the vertex, of the partially truncated rectangle is greater than or equal to 50 degrees.

In accordance with another embodiment of the present invention, shallow-recessed surfaces may not be disposed externally of the pair of leading-edge ABSs in the width direction thereof.

In accordance with one embodiment of the present invention, no shallow-recessed surfaces are disposed along ID sides of the pair of leading-edge ABSs, no shallow-recessed surface is disposed along an OD side of an OD leading-edge ABS of the pair of leading-edge ABSs, and a shallow-recessed surface is disposed only along a portion of an OD side of an ID leading-edge ABS of the pair of leading-edge ABSs.

In accordance with another embodiment of the present invention, a bridging ABS may be disposed between the pair of leading-edge ABSs, the bridging ABS connecting the pair of leading-edge ABSs.

In accordance with an embodiment of the present invention, a HDD includes a magnetic-recording disk and a head-slider configured to write data to and read data from the magnetic-recording disk. The head-slider of the HDD, which is as described above, includes: a pair of leading-edge ABSs formed on a leading-edge portion of a disk-facing slider-surface; a shallow-recessed surface formed proximate to the leading-edge portion of the leading-edge ABSs and between the leading-edge ABSs, the shallow-recessed surface being lower in height than the leading-edge ABSs; a center ABS formed at a central portion of a trailing-edge portion of the disk-facing slider-surface; a magnetic-recording head disposed that the central portion of the trailing-edge portion of the disk-spacing slider-surface; and a deep-recessed surface partially bounded by the leading-edge ABSs, the shallow-recessed surface and the center ABS, the deep-recessed surface being lower in height than the shallow-recessed surface. In accordance with an embodiment of the present invention, at least one, or alternatively one or more, leading-edge ABS of the pair has a form of a partially truncated rectangle with a longitudinal axis of the partially truncated rectangle oriented substantially parallel to a longitudinal axis of the head-slider. In accordance with an embodiment of the present invention, the partially truncated rectangle is defined by a rectangle truncated so that both a first corner portion on the ID side of the leading-edge ABS and a second corner portion on the OD side of the leading-edge ABS have been cut away to form a vertex of the partially truncated rectangle in proximity to the leading edge of the head-slider. In other words, with a vertex at a point on an OD side of a magnetic-recording disk in proximity to the leading-edge of the magnetic-recording head, a first corner portion defined on an ID side of the magnetic-recording head relative to the vertex and corresponding to a substantially triangular shape is removed from a substantial rectangle defined for each of the pair of leading-edge ABSs; and, a second corner portion defined on an OD side of the magnetic-recording head relative to the vertex and corresponding to another substantially triangular shape smaller than that of the first corner portion is removed from the rectangle defined for each of the pair of leading-edge ABSs to make the leading-edge portion of each of the leading-edge ABSs chevron-shaped. In accordance with embodiments of the present invention, the head-slider of the HDD includes the embodiments of the present invention described herein for the head-slider, as embodiments of the present invention for the head-slider may be included in an HDD including a head-slider.

In accordance with an embodiment of the present invention, a product of a cut-length in the longitudinal direction of the head-slider on the inside-diameter side of the first cut-away corner portion of the at least one of the pair of leading-edge ABSs and a square root of a speed at a MD of the magnetic-recording disk, as converted to a unit slider length of 1 mm, is greater than or equal to 0.6.

In accordance with embodiments of the present invention, the fly pitch of the head-slider on the disk OD portion of the magnetic-recording disk can be made smaller than the fly pitch on the ID portion of the magnetic-recording disk. This prevents, in the HDD, the magnetic-recording head of the head-slider from becoming the lowest point. As used herein, the term of art, “lowest point,” refers to the location on the disk-facing slider-surface that comes into closest proximity with the recording surface of the magnetic-recording disk, when the head-slider is flown over the recording surface of the magnetic-recording disk. In particular, reduced clearance can be prevented on the disk OD where the magnetic-recording disk spins at high speeds, as a consequence of the larger circumferential velocity at the OD for a fixed angular velocity. The magnetic-recording head or magnetic-recording disk can therefore be prevented from being damaged by a sliding motion of the magnetic-recording head. As a result, glide reliability of the HDD can be enhanced.

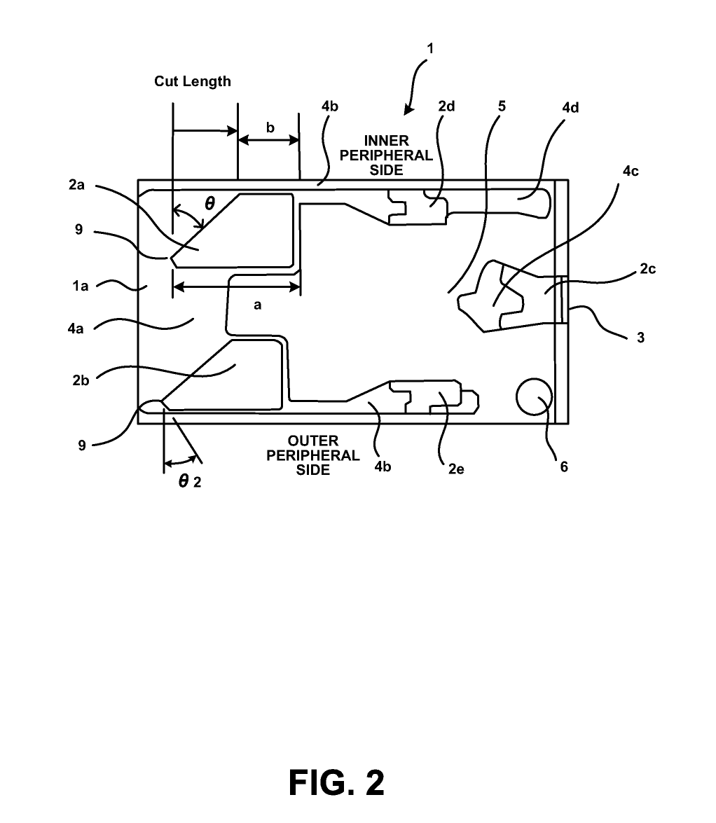

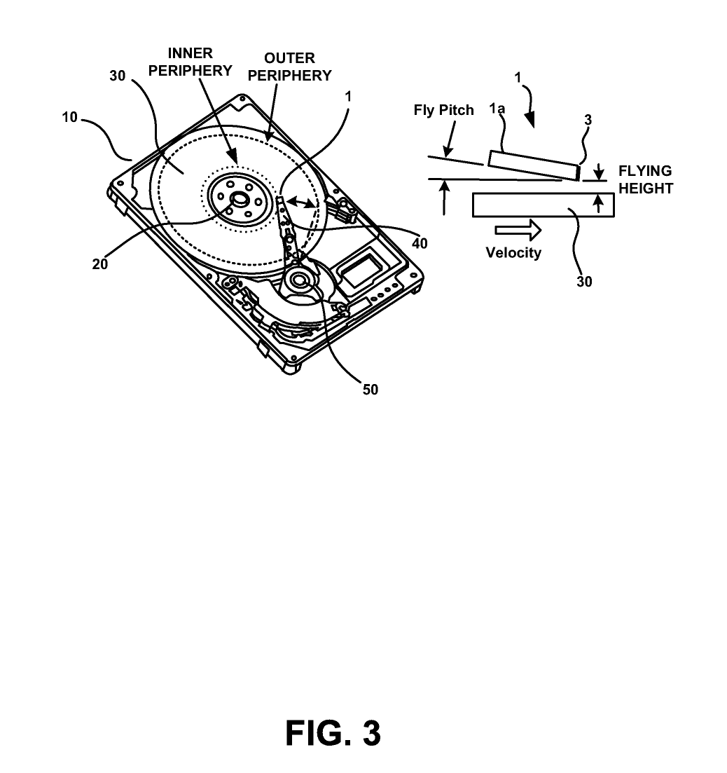

With reference now to FIG. 3, in accordance with an embodiment of the present invention, arrangements of a HDD and the fly pitch of a head-slider 1 above a magnetic-recording disk 30 are shown. A HDD 10 includes a spindle 20 rotated by a motor, a magnetic-recording disk 30 mounted on the spindle 20, and an actuator 50. The actuator 50 supports a head-slider 1 with a suspension 40 to allow the head-slider 1 to fly above a spinning magnetic-recording disk 30 and to position the slider 1 at any given radial position over the magnetic-recording disk 30. The head-slider 1 includes a slider 1a and a magnetic-recording head 3 (see FIG. 2) disposed at a trailing-edge portion of the slider 1a. The head-slider 1 flies in a skewed fashion relative to the spinning magnetic-recording disk 30 such that a leading edge portion of the head-slider 1 has a larger flying height than the trailing-edge portion of the head-slider 1, and the trailing-edge portion of the head-slider 1, at which the magnetic-recording head 3 is disposed, has a minimum flying height. As used herein, the term of art, “flying height,” which is identified with the term of art, “fly height,” refers to the distance that separates a portion of the ABS and a recording surface of a magnetic-recording disk when a head-slider flies over the recording surface of the magnetic-recording disk.

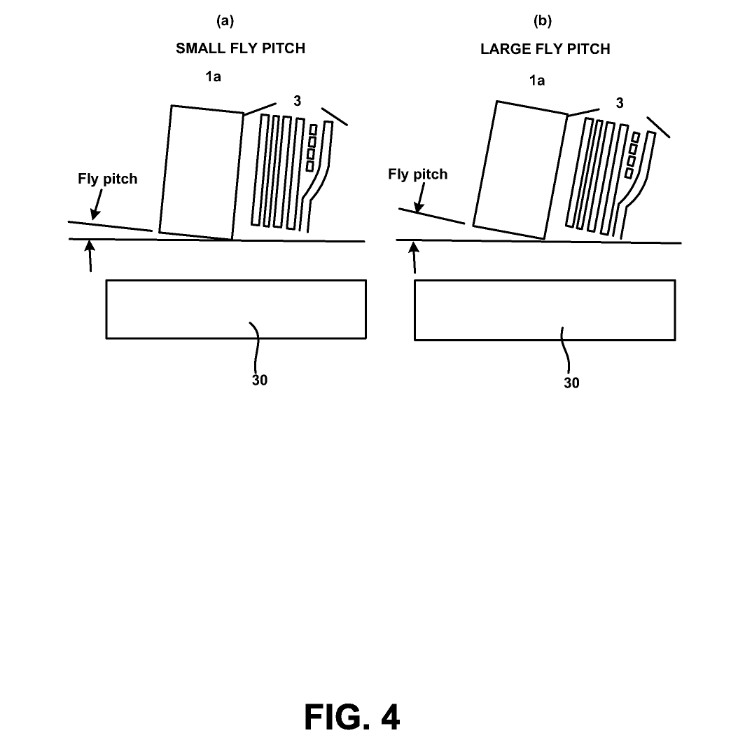

With reference now to FIG. 4, in accordance with an embodiment of the present invention, an enlarged view of the fly pitch of the magnetic-recording head 3 is shown. The magnetic-recording head 3 is recessed from the ABS of the slider 1a, which is referred to by the term of art, “head-recession.” If the slider fly pitch is small as shown in FIG. 4(a), therefore, a boundary between the slider 1a and the magnetic-recording head 3 becomes the lowest point. When the slider fly pitch becomes larger as shown in FIG. 4(b), however, the magnetic-recording head 3 becomes the lowest point. Embodiments of the present invention aim to prevent damage to a magnetic-recording head or damage to a magnetic-recording disk due to a sliding motion of the magnetic-recording head by having a fly pitch of a head-slider on the OD portion of a magnetic-recording disk smaller than that on the ID portion of the magnetic-recording disk.

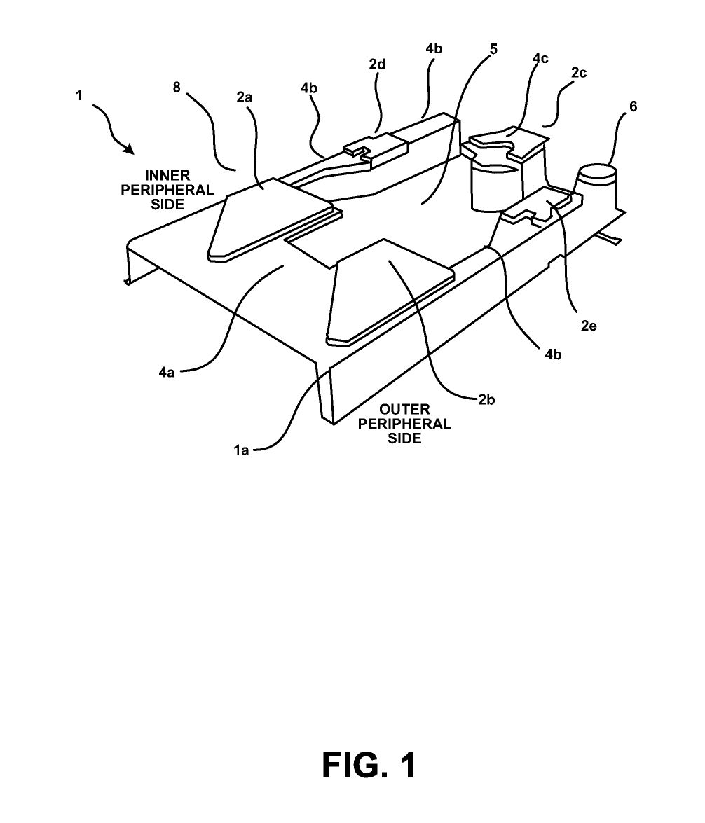

With reference now to FIGS. 1 and 2, in accordance with an embodiment of the present invention, a perspective view of the head-slider 1 is shown in FIG. 1; and, In FIG. 2, a plan view of FIG. 1 is shown. The head-slider 1 includes a leading-edge shallow-recessed surface 4a and a pair of leading-edge ABSs 2a and 2b, which generate lift on the head-slider 1 through the air-bearing effect. The leading-edge shallow-recessed surface 4a is disposed on the leading-edge portion of a disk-facing slider-surface 8 of the slider 1a. The pair of leading-edge ABSs 2a and 2b, which are higher than the leading-edge shallow-recessed surface 4a, are disposed rearward of the leading-edge shallow-recessed surface 4a. A shallow-recessed side-rail 4b extends behind of each of the leading-edge ABSs 2a and 2b up to a point near the trailing edge. The shallow-recessed side-rail 4b includes a pair of trailing-edge ABSs 2d, 2e. A center ABS 2c is disposed at a central portion, which is about midway along the width of the head-slider 1, of the trailing-edge portion of the slider 1a. The magnetic-recording head 3 is disposed in proximity to the center ABS 2c. A center shallow-recessed surface 4c is disposed on the leading-edge of the center ABS 2c. A deep-recessed surface 5 that is lower in height than the shallow-recessed surfaces 4a, 4b, and 4c is disposed at a central portion partially bounded by the leading-edge shallow-recessed surface 4a, the leading-edge ABSs 2a and 2b, the shallow-recessed side-rail 4b, and the center shallow-recessed surface 4c. Note that the leading-edge ABSs 2a and 2b and the center ABS 2c are of the same height; and, the leading-edge shallow-recessed surface 4a, the shallow-recessed side-rail 4b, and the center shallow-recessed surface 4c are of the same height. A depth d1 of the shallow-recessed surfaces (4a, 4b, and 4c) below the ABSs (2a, 2b, and 2c) is about 200 nm; and, a depth of the deep-recessed surface 5 below the ABSs is about 1700 nm. In addition, the slider length is 1.25 mm and the slider width is 0.7 mm.

With further reference to FIGS. 1 and 2, in accordance with an embodiment of the present invention, with a vertex 9 at a point on an OD side of a magnetic-recording disk 30 during mounting of the slider to a drive in a width direction on the leading-edge, a first corner portion defined on an ID side of the magnetic-recording disk 30 relative to the vertex and corresponding to a substantially triangular shape is removed from a substantial rectangle defined in each of the pair of leading-edge ABSs 2a and 2b in a longitudinal direction that is a trailing-edge direction of the slider 1a. A second corner portion defined on an OD side of the magnetic-recording disk 30 relative to the vertex 9 and corresponding to another substantially triangular shape smaller than that of the first corner portion is removed from the rectangle. Accordingly, each of the leading-edges of the leading-edge ABSs 2a and 2b is chevron-shaped. The chevron shape allows the increase in the fly pitch to be adjusted from the MD to OD of the magnetic-recording disk 30.

With further reference to FIGS. 1 and 2, in accordance with an embodiment of the present invention, when the head-slider 1 is configured in juxtaposition to the magnetic-recording disk 30, the arrangements of the leading-edge shallow-recessed surface 4a and the leading-edge ABSs 2a and 2b compress an airflow produced through spinning of the magnetic-recording disk 30 to generate a lift through the air-bearing effect. On the deep-recessed surface 5, conversely, the airflow expands to generate a negative pressure. The head-slider 1 flies when the air-bearing force balances load applied by the suspension 40 that supports the head-slider 1. The flying height is 10 nm or less at the magnetic-recording head 3. The trailing-edge ABSs 2d, 2e serve for enhancing air film stiffness of the slider 1a in the width direction, which is the roll direction. In addition, a trailing-edge pad 6 is disposed at a trailing-edge portion on the OD side. The trailing-edge pad 6 avoids contact between a corner of the slider 1a and the magnetic-recording disk 30 when the head-slider 1 is loaded onto the magnetic-recording disk 30, which reduces the potential for contact damage due to a HDI.

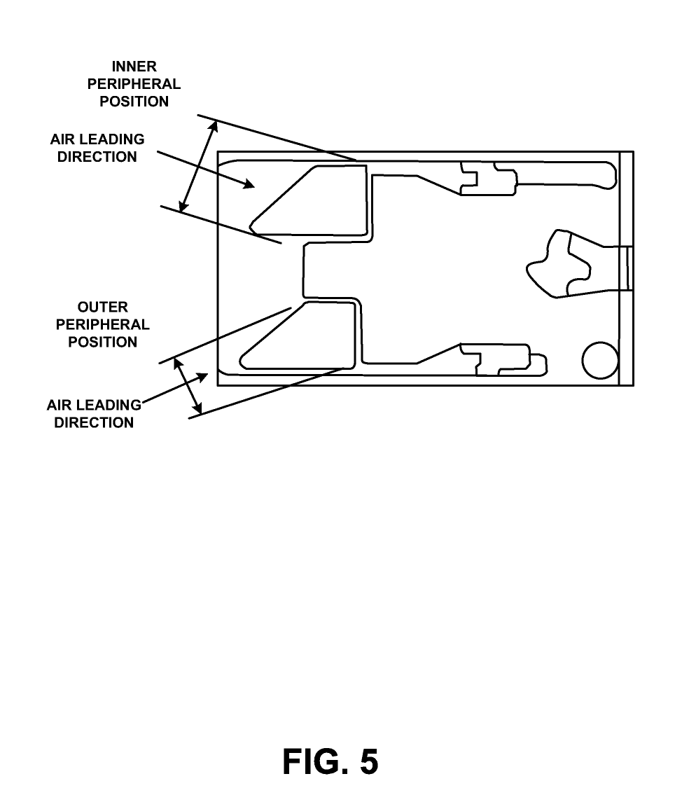

With reference now to FIG. 5, in accordance with an embodiment of the present invention, a relationship is shown between the air leading direction and the leading-edge ABSs 2a and 2b at an ID position and an OD position of the magnetic-recording disk 30 when the head-slider 1 is configured within the HDD. The air flows over the leading-edge shallow-recessed surface 4a with the depth d1 on the leading-edge and reaches the leading-edge ABSs 2a and 2b. The air generates a positive pressure through a step bearing effect. Because of the void portion of the large substantially triangular shape defined on the ID side of each of the leading-edge ABSs 2a and 2b, on one hand, the step bearing is wide on the leading-edge at the ID position to increase the positive pressure; on the other hand, the shorter ABS length decreases the positive pressure, so that the fly pitch at the ID position increases slightly. At the OD position, in contrast, the large substantially triangular shape on the ID side results in a narrow step bearing on the leading-edge, so that the positive pressure decreases. As a result, the lift on the leading-edge ABSs 2a and 2b at the MD to OD positions can be held lower as compared with that at the ID position. Thus, the fly pitch on the OD portion of the magnetic-recording disk 30 can be made smaller than that on the ID portion of the magnetic-recording disk 30.

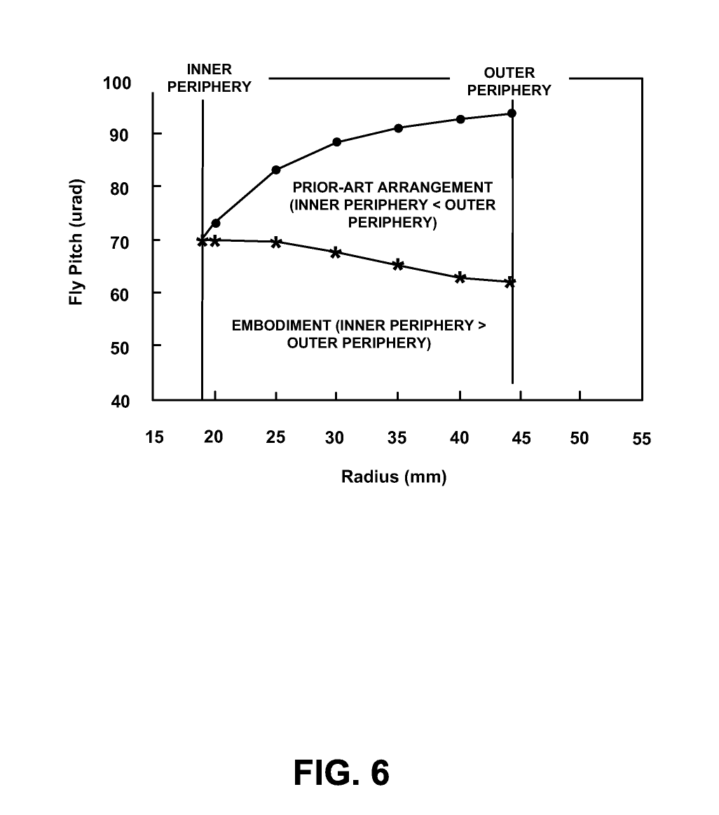

With reference now to FIG. 6, in accordance with an embodiment of the present invention, a chart shows changes in the fly pitch of the head-slider 1 from the ID to the OD of the magnetic-recording disk 30. An ID skew angle is about −16 degrees and an OD skew angle is about 12 degrees. While the fly pitch in the prior-art arrangement increases toward the OD from the ID, the fly pitch of the head-slider 1 according to the embodiment of the present invention decreases toward the OD from the ID. As a result, the magnetic-recording head 3 of the head-slider 1 can avoid from becoming the lowest point on the OD side at which the magnetic-recording disk 30 spins at high speeds. Reduction in clearance on the OD can thereby be prevented and damage of the magnetic-recording head 3 and the magnetic-recording disk 30 caused by sliding of the magnetic-recording head 3 can be prevented. In accordance with embodiments of the present invention, for the head-slider 1 as described in the discussion of FIGS. 1-6, the pair of leading-edge ABSs and the center ABS at the trailing-edge portion are disposed separately from each other. Accordingly, the shape of the leading-edge ABS does not have a large affect on the flying height of the magnetic-recording head 3 at the trailing-edge portion. The relationship between the shape of the leading-edge ABS and the fly pitch is next described.

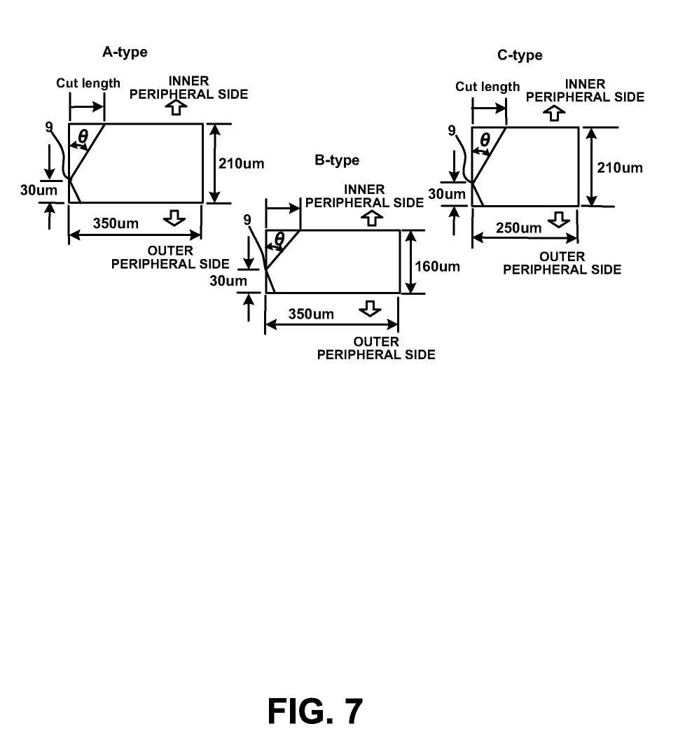

With reference now to FIG. 7, in accordance with embodiments of the present invention, typical shapes of a leading-edge ABS are shown. A-type is a 350-um-long-by-210 um-wide rectangle, B-type is a 350-um-long-by-160 um-wide rectangle, and C-type is a 250-um-long-by-210 um-wide rectangle. The outer small right triangle on the OD side has a constant cut-length of 20 um.

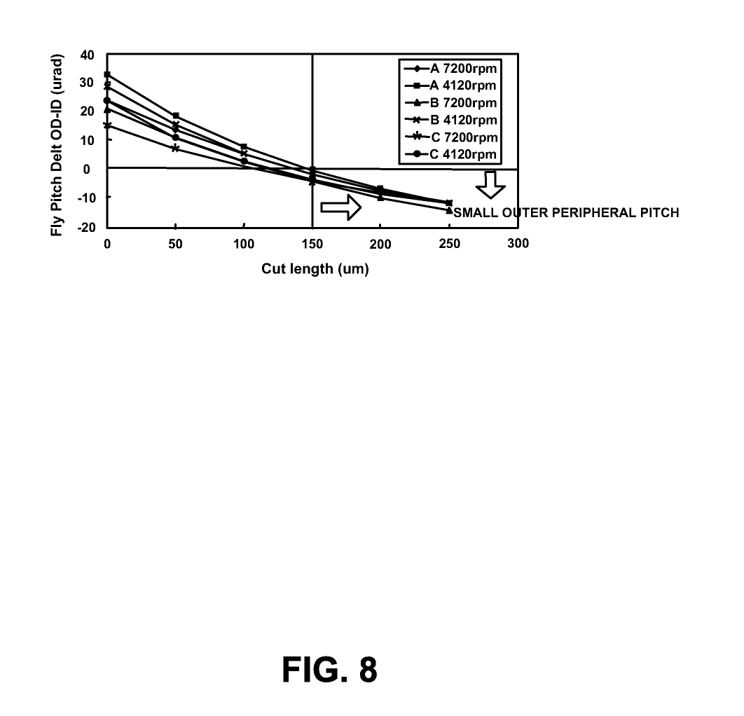

With reference now to FIG. 8, in accordance with an embodiment of the present invention, a chart shows a relationship between cut-length and changes in OD and ID fly pitches. The chart shows results of two different disk speeds of 7200 rpm and 4120 rpm. In any of the types of leading-edge ABS and disk speeds, the OD fly pitch is smaller than the ID fly pitch at a cut-length of 150 um or more.

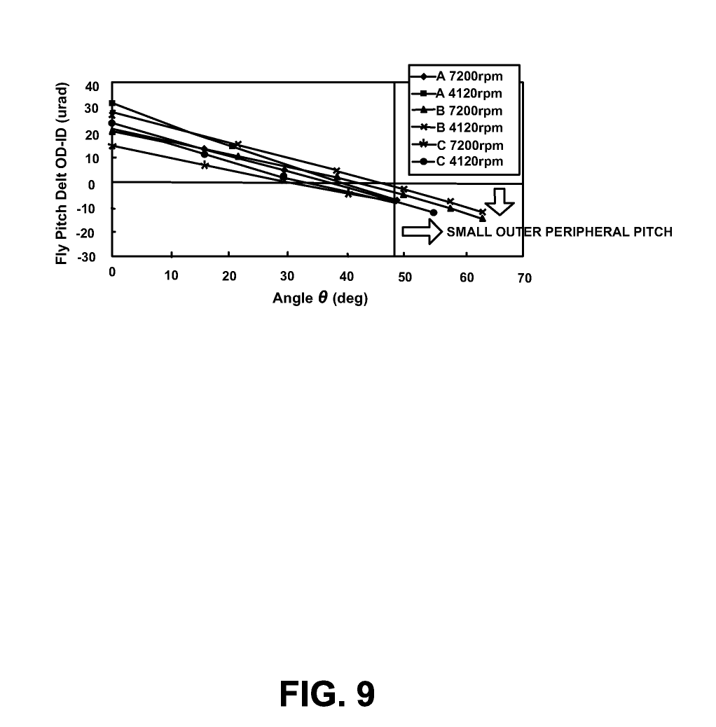

With reference now to FIG. 9, in accordance with an embodiment of the present invention, a chart shows a relationship between cut-angle θ and changes in the OD and ID fly pitches.

With further reference to FIG. 7, in accordance with an embodiment of the present invention, the cut-angle θ may be defined as an angle θ of a substantially triangular shape cut away from the corner portion of the rectangle on the ID side at the leading-edge vertex of the leading-edge ABS. In any of the types of leading-edge ABS and disk speeds, the OD fly pitch is smaller than the ID fly pitch at a cut-angle of 50 degrees or more.

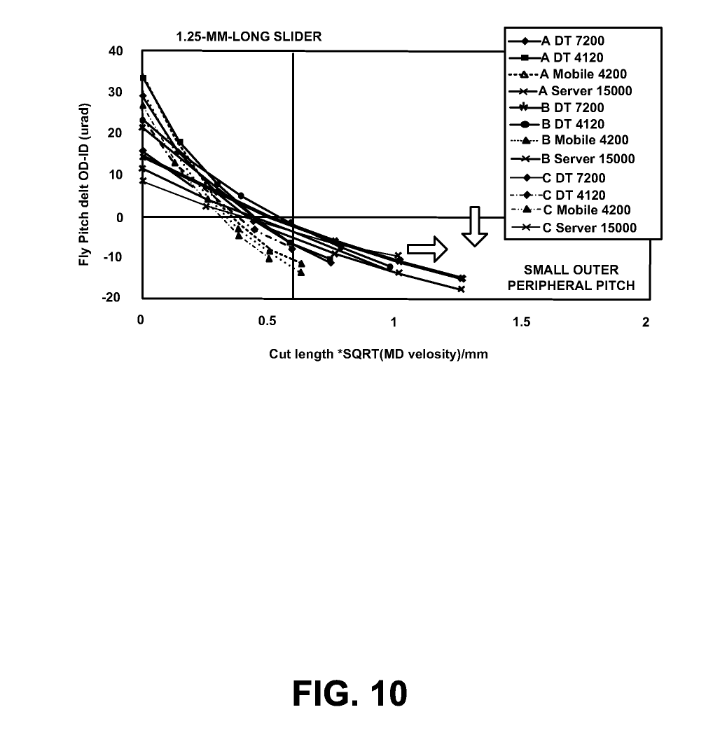

With reference now to FIG. 10, in accordance with an embodiment of the present invention, a chart that compares differences between the ID and OD fly pitches (OD-ID) for various disk sizes and speeds for the 1.25-mm-long slider is shown. If the product of square root of speed at the MD of a magnetic-recording disk (SQRT (MD velocity)) and cut-length converted to a unit slider length (1 mm) is plotted on the abscissa and the difference in fly pitch between the OD and ID is plotted on the ordinate, then a generally constant width curve is obtained under various conditions. In the figure, DT represents an HDD built for a desktop PC, Mobile represents an HDD built for a mobile PC, and Server represents an HDD built for a server.

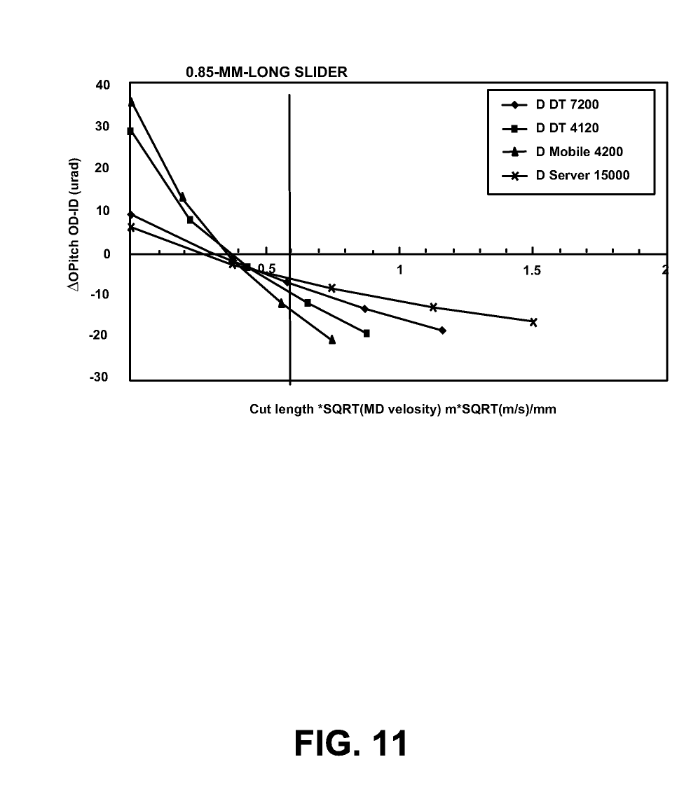

With reference now to FIG. 11, in accordance with an embodiment of the present invention, results for a 0.85-mm-long slider are shown. Plotting against the same abscissa as in FIG. 10 substantially similar curves to those shown in FIG. 10 are obtained. These results show that having a value of 0.6 or more on the abscissa allows the OD fly pitch to be smaller than the ID fly pitch regardless of whether the 1.25-mm-long slider or 0.85-mm-long slider is used for a wide variety of drive conditions.

In the head-slider according to the prior-art, the slider fly pitch increases with the greater speed of the magnetic-recording disk at the OD, so that the position of the lowest point on the head-slider moves to the location of the magnetic-recording head on the head-slider; as a result, potential sliding motion of the magnetic-recording head may damage the magnetic-recording head or the magnetic-recording disk, leading to reduced glide reliability. In accordance with embodiments of the present invention, however, by having a fly pitch of the slider smaller on the OD than on the ID, the magnetic-recording head 3 of the head-slider 1 can avoid becoming the lowest point and, in particular, reduced clearance can be prevented on the OD where the magnetic-recording disk spins at high speeds. The magnetic-recording head 3 or magnetic-recording disk 30 can therefore be prevented from being damaged by a sliding motion of the magnetic-recording head 3. Therefore, in accordance with embodiments of the present invention, increased glide reliability of the HDD and enhanced quality of the HDD may be achieved.

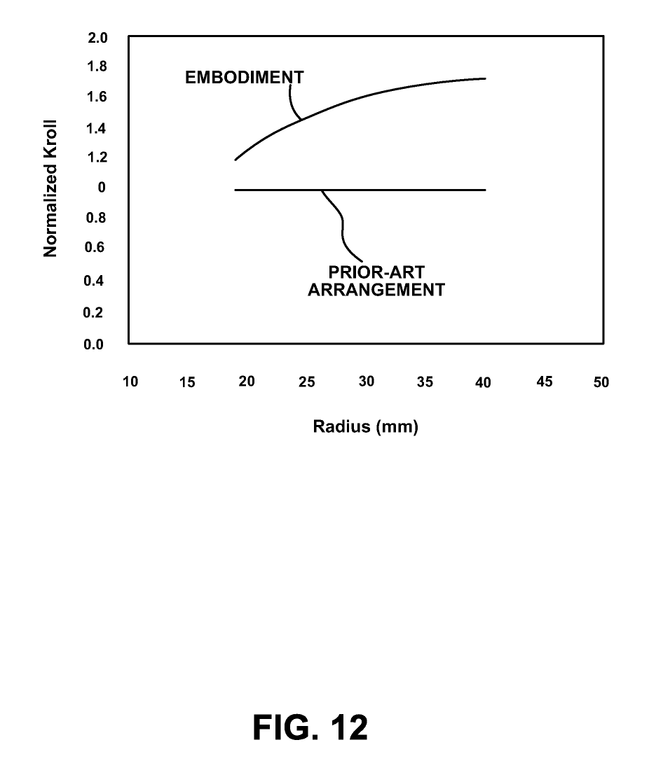

With reference now to FIG. 12, in accordance with an embodiment of the present invention, a chart shows roll stiffness of the head-slider 1. FIG. 12 also shows relative difference in roll stiffness of an embodiment of the present invention compared to the prior-art arrangement. The roll stiffness remains substantially equal to that of the prior-art arrangement on the ID, but increases by about 50% on the OD. This indicates that head-slider oscillations that may arise from a disturbance in the flight of the head-slider can be inhibited, so that the head-slider 1 can be reliably lifted. A head-slider according to a modified example of embodiments of the present invention is next described.

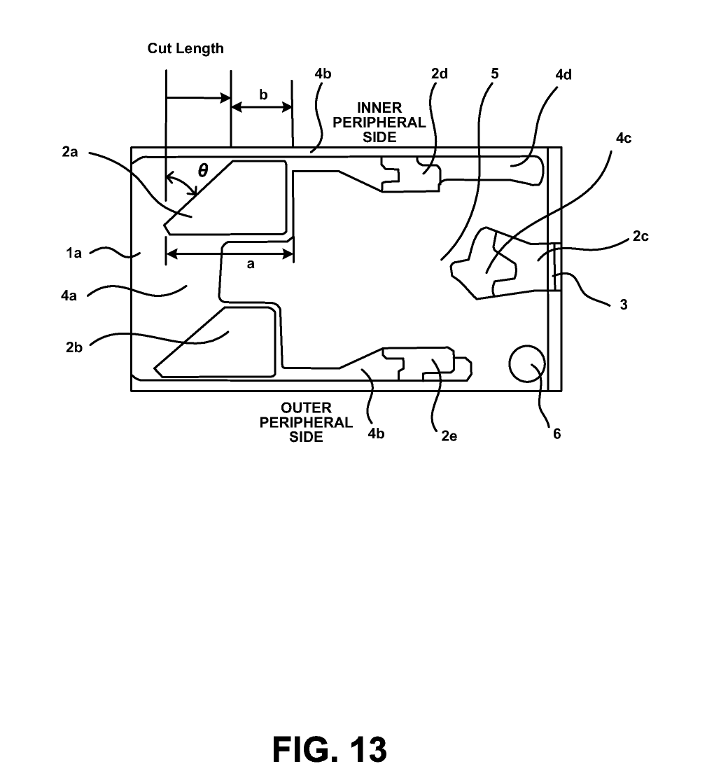

With reference now to FIG. 13, in accordance with an embodiment of the present invention, a plan view shows a first modified example. In this first modified example, no shallow-recessed surfaces are disposed on the sides of the leading-edge ABSs 2a and 2b in proximity to the long sides of the head-slider, which has the substantially rectangular shape as shown in FIG. 13. In this example, too, the magnetic-recording head 3 of the head-slider can avoid becoming the lowest point, when the head-slider is flown over the magnetic-recording disk; and, reduced clearance between the head-slider and the recording surface of the magnetic-recording disk on the OD can be prevented by having a fly pitch of the slider smaller on the OD than on the ID. Accordingly, for this first modified example, the same effect of preventing damage to a magnetic-recording head or damage to a magnetic-recording disk that may be caused by the sliding motion of the magnetic-recording head can be achieved as for other embodiments of the present invention.

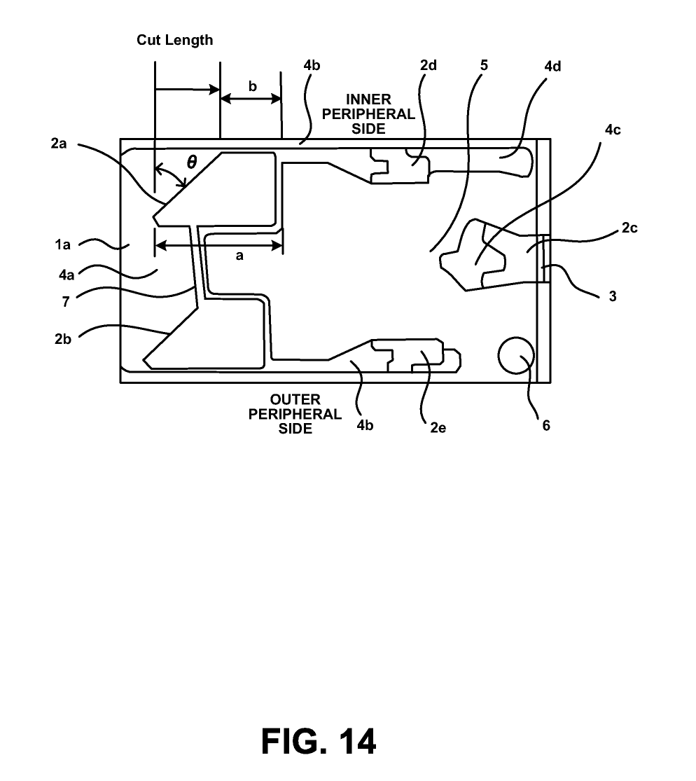

With reference now to FIG. 14, in accordance with an embodiment of the present invention, a plan view shows a second modified example. In this second modified example, a bridging ABS 7 is disposed between the leading-edge ABSs 2a and 2b to connect the leading-edge ABSs 2a and 2b. For this second modified example, it has been verified that the same effect of preventing damage to a magnetic-recording head or damage to a magnetic-recording disk that may be caused by the sliding motion of the magnetic-recording head can also be achieved as for other embodiments of the present invention.

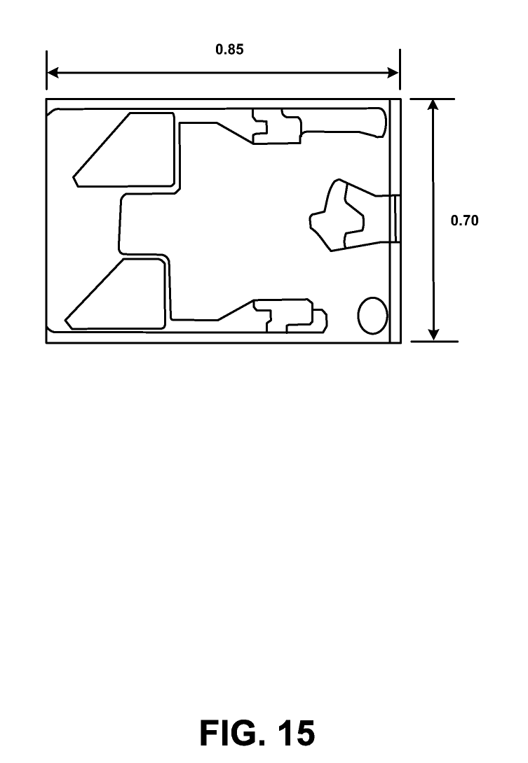

With reference now to FIG. 15, in accordance with an embodiment of the present invention, an example, in which the present invention is applied to a 0.85-mm-long-by-0.7-mm-wide slider, is shown. The head-slider shown in FIGS. 1 and 2 is 1.25 mm long and 0.7 mm wide. For the slider having a length of 0.85 mm and a width of 0.7 mm, it has been verified that the same effect of preventing damage to a magnetic-recording head or damage to a magnetic-recording disk that may be caused by the sliding motion of the magnetic-recording head can also be achieved as for other embodiments of the present invention.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A head-slider comprising:
a pair of leading-edge air-bearing surfaces formed on a leading-edge portion of a disk-facing slider-surface of said head-slider;
a center air-bearing surface formed at a central portion of a trailing-edge portion of said disk-facing slider-surface; and
a magnetic-recording head disposed at said central portion of said trailing-edge portion;
wherein at least one leading-edge air-bearing surface of said pair has a form of a partially truncated rectangle with a longitudinal axis of said partially truncated rectangle oriented substantially parallel to a longitudinal axis of said head-slider, said partially truncated rectangle defined by a rectangle truncated so that both a first corner portion on said inside-diameter side of said leading-edge air-bearing surface and a second corner portion on said outside-diameter side of said leading-edge air-bearing surface have been cut away to form a vertex of said partially truncated rectangle in proximity to said leading edge of said head-slider.

2. The head-slider of claim 1, further comprising:
a shallow-recessed surface formed proximate to a leading-edge portion of said leading-edge air-bearing surfaces and between said leading-edge air-bearing surfaces, said shallow-recessed surface being lower in height than said leading-edge air-bearing surfaces.

3. The head-slider of claim 1, further comprising:
a deep-recessed surface partially bounded by said leading-edge air-bearing surfaces, said shallow-recessed surface and said center air-bearing surface, said deep-recessed surface being lower in height than said shallow-recessed surface;

4. The head-slider of claim 1, wherein said first cut-away corner portion is larger than said second cut-away corner portion.

5. The head-slider of claim 1, wherein a leading-edge portion of said at least one leading-edge air-bearing surface of said pair including said vertex of said partially truncated rectangle has a chevron-like shape.

6. The head-slider of claim 1, wherein both said first cut-away corner portion and said second cut-away corner portion have a substantially triangular shape.

7. The head-slider of claim 6, wherein said first cut-away corner portion has a cut-length on said inside-diameter side greater than or equal to 150 um in said longitudinal direction of said head-slider.

8. The head-slider of claim 6, wherein an angle of said first cut-away corner portion adjacent to said vertex of said partially truncated rectangle is greater than or equal to 50 degrees.

9. The head-slider of claim 1, wherein no shallow-recessed surfaces are disposed along inside-diameter sides of said pair of leading-edge air-bearing surfaces, no shallow-recessed surface is disposed along an outside-diameter side of an outside-diameter leading-edge air-bearing surface of said pair of leading-edge air-bearing surfaces, and a shallow-recessed surface is disposed only along a portion of an outside-diameter side of an inside-diameter leading-edge air-bearing surface of said pair of leading-edge air-bearing surfaces.

10. The head-slider of claim 1, further comprising:
a bridging air-bearing surface disposed between said pair of leading-edge air-bearing surfaces, said bridging air-bearing surface connecting said pair of leading-edge air-bearing surfaces.

11. A hard-disk drive, comprising:
a magnetic-recording disk; and
a head-slider configured to write data to and read data from said magnetic-recording disk, said head-slider comprising:
a pair of leading-edge air-bearing surfaces formed on a leading-edge portion of a disk-facing slider-surface;
a center air-bearing surface formed at a central portion of a trailing-edge portion of said disk-facing slider-surface; and
a magnetic-recording head disposed at said central portion of said trailing-edge portion;
wherein at least one leading-edge air-bearing surface of said pair has a form of a partially truncated rectangle with a longitudinal axis of said partially truncated rectangle oriented substantially parallel to a longitudinal axis of said head-slider, said partially truncated rectangle defined by a rectangle truncated so that both a first corner portion on said inside-diameter side of said leading-edge air-bearing surface and a second corner portion on said outside-diameter side of said leading-edge air-bearing surface have been cut away to form a vertex of said partially truncated rectangle in proximity to said leading edge of said head-slider.

12. The head-slider of claim 11, further comprising:
a shallow-recessed surface formed proximate to a leading-edge portion of said leading-edge air-bearing surfaces and between said leading-edge air-bearing surfaces, said shallow-recessed surface being lower in height than said leading-edge air-bearing surfaces.

13. The head-slider of claim 11, further comprising:
a deep-recessed surface partially bounded by said leading-edge air-bearing surfaces, said shallow-recessed surface and said center air-bearing surface, said deep-recessed surface being lower in height than said shallow-recessed surface;

14. The head-slider of claim 11, wherein said first cut-away corner portion is larger than said second cut-away corner portion.

15. The head-slider of claim 11, wherein a leading-edge portion of said at least one leading-edge air-bearing surface of said pair including said vertex of said partially truncated rectangle has a chevron-like shape.

16. The hard-disk drive of claim 11, wherein a product of a cut-length in said longitudinal direction of said head-slider on said inside-diameter side of said first cut-away corner portion of said at least one of said pair of leading-edge air-bearing surfaces and a square root of a speed at a middle diameter of said magnetic-recording disk, as converted to a unit slider length of 1 mm, is greater than or equal to 0.6.

17. The head-slider of claim 11, wherein both said first cut-away corner portion and said second cut-away corner portion have a substantially triangular shape.

18. The hard-disk drive of claim 17, wherein said first cut-away corner portion has a cut-length on said inside-diameter side greater than or equal to 150 um in said longitudinal direction of said head-slider.

19. The hard-disk drive of claim 17, wherein an angle of said first cut-away corner portion adjacent to said vertex of said partially truncated rectangle is greater than or equal to 50 degrees.

20. The hard-disk drive of claim 11, further comprising:
a bridging air-bearing surface disposed between said pair of leading-edge air-bearing surfaces, said bridging air-bearing surface connecting said pair of leading-edge air-bearing surfaces.
